(19) United States
(12) Patent Application Publication
(10) Pub. No.: US 2007/0102241 A1
(43) Pub. Date: May 10, 2007

(54) Net system

(76) Inventor: John Rexroad, Killingworth, CT (US)

Correspondence Address: VENABLE, CAMPILLO, LOGAN & MEANEY, P.C., 1938 E. OSBORN RD, PHOENIX, AZ, 85016-7234, US

(21) Appl. No.: 11/269,242

(22) Filed: Nov. 7, 2005

(51) Int. Cl. A62B 1/22

(52) U.S. Cl. 182/138

(57) ABSTRACT

Described is a net system that attaches to buildings or structures undergoing maintenance, renovation, or construction. The net system is comprised of at least one mounting apparatus, at least one cantilever arm, and a net. These components work together to create a net system that encompasses a structure while still allowing sufficient clearance between the net and the structure for a swing stage or other types of construction equipment to easily move. The cantilever aims and mounting apparatuses are positioned around the building in an arrangement where the cantilever arms support a net system around the exterior of a building. The net system comprises multiple large nets that are coupled to the ends of the cantilever arms with fasteners. The large nets are connected to each other with fasteners such as hooks, loops, wire, or rope and form a continuous protective barrier around the building. While the net system can encompass the entire building, it is also possible to place the net system on a smaller area if necessary.

### BACKGROUND

The present invention relates generally to an apparatus used for maintaining a safe work environment, more particularly, to an apparatus that comprises a net system that maintains a safe work area for construction crews, members of the public, and property that are near a building undergoing construction or renovations. Specifically, the present invention utilizes a safety net system that is coupled to a building or structure and includes a cantilever arm that rotates between an open and closed position for maintenance on the net, protection of the net system in inclement weather, and added protection of the crew members, members of the public, and property.

A crew maintaining, renovating, or constructing a high-rise building or structure must deal with many hazards in the work environment. Members of the crew on the ground and in the air must be constantly aware of their surroundings to prevent injuries from falls or falling objects. Additionally, the public on the premises of a construction project must be aware of potentially hazardous situations, such as dropped objects falling from above that could cause bodily injury or property damage.

One way to ensure protection of the crew, public, and property is to install a safety net system that surrounds the perimeter of a building or structure near the area where objects may fall. However, it may be difficult to install a safety net system around a building while still allowing clearance between the net system and the building so that work can be done on the building exterior. Because a safety net system may hinder work on the outside of the building, the crew may not install a safety net system causing the potential for serious injury or damage to result.

The present invention provides crew members with a way to install a safety net system that provides clearance between the building and the net system. The present invention is a perimeter net system that includes at least one mounting apparatus, at least one cantilever arm, and a net. A net is coupled to an end of the cantilever arms such that the net adjusts as the cantilever arms rotate, and they form a barrier around the structure. The opposite ends of the cantilever arms are rotatably coupled to the mounting apparatuses that are coupled to a structure.

Currently, there are devices that use nets attached to buildings or structures to protect people working on maintenance or construction crews, the members of the public, and property on the ground that could be damaged by falling objects. However, each of these devices suffers from several disadvantages. First, the devices do not provide enough clearance between the net and the exterior of the building to allow crews to work. Second, the devices do not rotate allowing the net to be repaired or protected from inclement weather conditions such as wind. Finally, the devices are difficult to install. The devices contain many parts and require a difficult multi-step process including using a staging around the building or structure.

Presently, there is no net system that encompasses a building and provides adequate clearance between the net and exterior of the building while still providing an easy way to repair and protect the net. For the foregoing reasons, there is a need for a device that would allow construction crews to easily install and repair a net system that encompasses a building while still allowing the crew to work on the exterior of the building.

### SUMMARY

The present invention is directed to a device that satisfies the needs of providing a net system that encompasses the exterior of a building, providing a net system that allows sufficient clearance between the net and the exterior of the building to which it is attached, providing a net system that allows for ventilation, providing a net system that is rotatable so that installation can be done without staging, providing a net system that can be protected from inclement weather conditions such as high winds, providing a net system that extends past the reach of workers to prevent vandalism, and providing a net system that prevents objects from being thrown or blown off of buildings or structures.

A net system having features of the present invention comprises at least one mounting apparatus, at least one cantilever arm, and a net. The cantilever arms include a first end and a second end, where the first ends of the cantilever arms are coupled to the mounting apparatuses such that the cantilever arms rotate. Moreover, the mounting apparatuses are coupled to a structure. The second ends of the cantilever arms are coupled to a net that adjusts between and open position and a closed position as the cantilever arm rotates and forms a barrier around the structure.

It is an object of the present invention to provide a net system that encompasses the exterior of a building.

It is a further object of the present invention to provide a net system that provides sufficient clearance between the net and the exterior of the building.

It is a further object of the present invention to provide a net system that allows for ventilation.

It is a further object of the present invention to provide a net system that rotates so that installation of the net system can be done without staging.

It is a further object of the present invention to provide a net system that can be protected from inclement weather conditions and high winds.

It is a further object of the present invention to provide a net system that extends past the reach of workers on the building to prevent vandalism.

It is a further object of the present invention to provide a net system that prevents objects from being thrown or blown off of structures.

The novel features that are considered characteristic of the invention are set forth with particularity in the appended claims. The invention itself, however, both as to it structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C.§112, paragraph 6 to define the invention. To the contrary, if the provisions of 35 U.S.C.§112, paragraph 6 are sought to be invoked to define the invention(s), the claims will specifically state the phrases “means for” or “step for” and a function, without also reciting in such phrases any structure, material, or act in support of the function.

Moreover, even if the provisions of 35 U.S.C.§112, paragraph 6 are invoked to define the inventions, it is intended that the inventions not be limited only to the specific structure, material or acts that are described in the preferred embodiments, but in addition, include any and all structures, materials or acts that perform the claimed function, along with any and all known or later developed equivalent structures, materials, or acts for performing the claimed function.

### BRIEF DESCRIPTION OF THE DRAWINGS

FIG. 1 shows a side view of the net system with the cantilever arms and net in the open position and attached to the structure with clamp mounts. A swing stage is shown positioned between the net and the exterior of the structure.

FIG. 2 shows an alternate embodiment of the net system as in FIG. 1 attached to the structure with a mounting plate.

FIG. 3 shows a side view the net system as in FIG. 1.

FIG. 4 shows an alternate embodiment of the net system as in FIG. 1 attached to the structure with a parapet clamp mount.

FIG. 5 shows an alternate embodiment of the net system as in FIG. 1 attached to the structure with an eyebolt.

FIG. 6 shows an alternate embodiment of the net system as in FIG. 1 attached to the structure with a web mount.

FIG. 7 shows the net system as in FIG. 1 in the closed position with the cantilever arm in a vertical position and the net in a vertical position against the structure.

### DESCRIPTION OF PREFERRED EMBODIMENTS

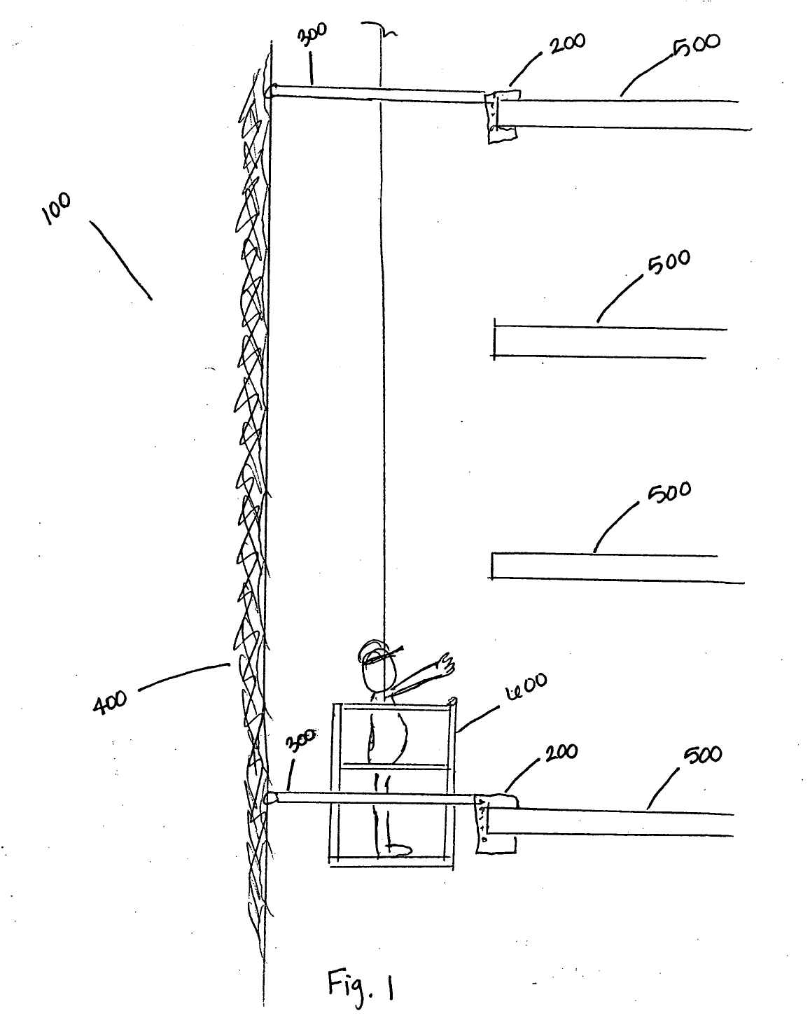

A side view of a net system 100 is shown in FIG. 1. The preferred embodiment of the net system 100 is comprised of at least one mounting apparatus 200, at least one cantilever arm 300, and a net 400. These components work together to create a net system 100 that encompasses a structure 500 while still allowing sufficient clearance between the net 400 and the structure 500 for a swing stage 600 or other types of construction equipment to easily move.

Cantilever arms 300 and mounting apparatuses 200 are positioned around the building or structure in an arrangement where the cantilever aims 300 support a net system 100 around the exterior of a building or structure. The net system 100 comprises multiple large nets 400 that are coupled to the second ends 310 of the cantilever arms 300 with fasteners 350. Further, the large nets 400 are connected to each other with fasteners such as hooks, loops, wire, or rope and form a continuous protective barrier around the building or structure. While the net system 100 can encompass the entire building or structure, it is also possible to place the net system 100 around a smaller area if desired.

The first ends 320 of the cantilever arms 300 are attached to the mounting apparatus 200 with pivot pins 330 and rotate around the axis of the pivot pin 330 between an open and closed position. This configuration allows the net 400 to be deployed at various angles. When in the closed position, the net 400 is against the structure 500. When in the open position, the net 400 is deployed at some angle between the closed position and 90°. The mounting apparatuses 200 attach the cantilever arms 300 and the net 400 to the structure 500 ultimately providing protection to the crew, members of the public, and property below the structure 500 from falling objects. Additionally, the adjustability of the net 400 ensures that the net 400 is easily repaired and protected from inclement weather conditions and high winds.

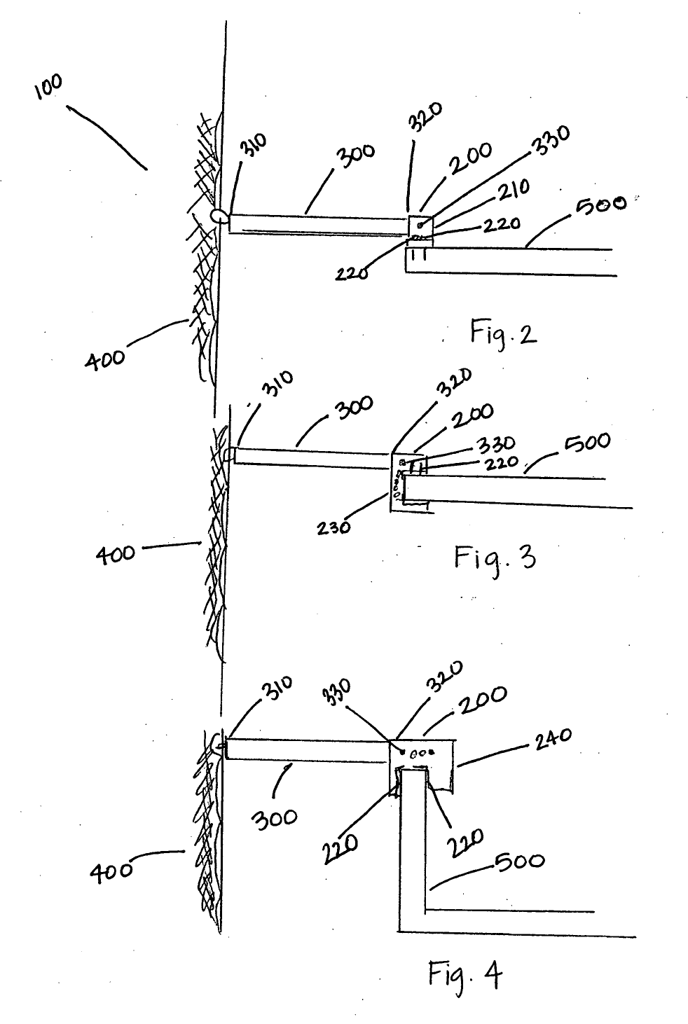

FIGS. 2-6 show side views of alternate embodiments of the net system 100 attached to structures 500 with various mounting apparatuses 200, and the net 400 in the open position. In FIG. 2, the mounting apparatus 200 is a mounting plate 210. The mounting plate 210 attaches to one side of the beam structure 500 with fasteners 220, such as bolts or pins. A pivot pin 330 couples the cantilever arm 300 to the mounting plate 210 so that the cantilever arm 300 can rotate between an open and closed position.

In FIG. 3, the net system 100 is attached to the beam structure 500 with a clamp mount 230. As described above, the clamp mount 230 is attached to the structure 500 with fasteners 220, such as bolts or pins. The clamp mount 230 fits around the edge of the beam structure 500 and can be adjusted to fit various size beams. The clamp mount 230 comprises separate top and bottom pieces that are adjustably connected. When the desired width of the clamp mount 230 is achieved, the top and bottom piece of the clamp mount 230 are secured to each other and then onto the beam structure 500. The cantilever arm 300 is coupled to the top piece of the clamp mount 230 with a pivot pin 330 so that the cantilever arm 330 can rotate around the axis of the pivot pin 330 between an open or closed position.

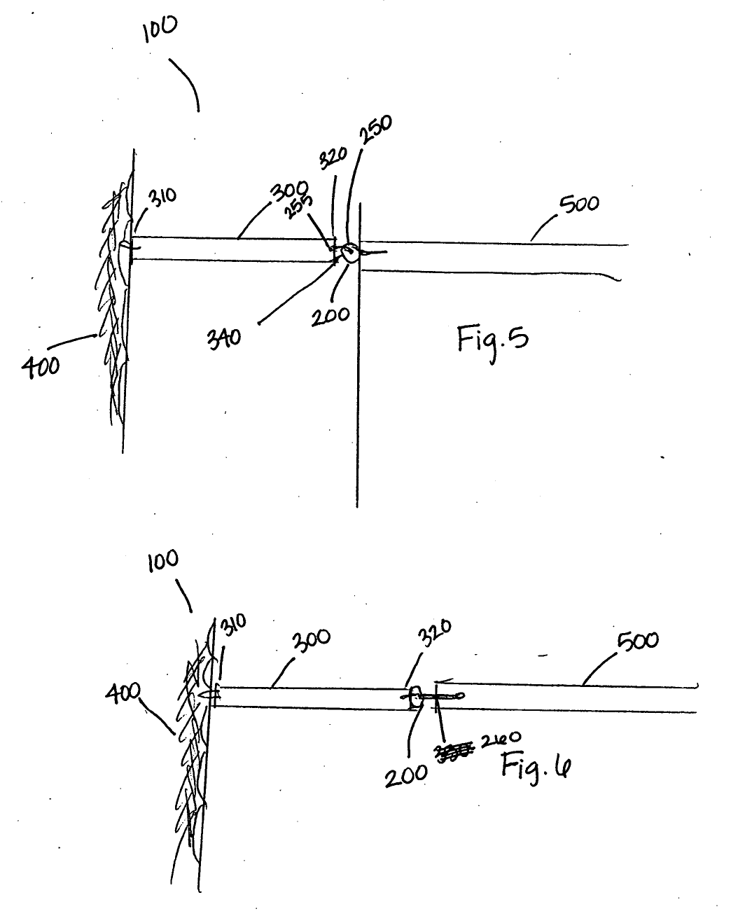

The parapet clamp mount 240 in FIG. 4 is similar to the clamp mount 230 in FIG. 3. The parapet clamp mount 240 attaches around the edge of a parapet wall structure 500 and can be adjusted to fit parapet walls of varying sizes. The parapet clamp mount 240 can also include two separate pieces that are adjusted and then secured together like the clamp mount 230. Fasteners 220, such as bolts or pins attach the parapet clamp mount 240 to the parapet wall structure 500. Moreover, a pivot pin 330 attaches the cantilever arm 300 to one piece of the parapet clamp mount 240 so that the cantilever arm 300 can rotate between an open and closed position. The parapet clamp mount 240 is preferred when the structure 50 consists of a parapet wall such as around a roof of a building.

FIG. 5 shows an embodiment of the net system 100 where the cantilever arm 300 is attached to the beam structure 500 with an eyebolt 250. The eyebolt 250 is a preferred embodiment because it can be left in the beam structure 500 after the net system 100 is removed and used for future applications. The cantilever arm 300 attaches to the eyebolt 250 with a wire 340. The wire 340 is inserted through the eyebolt 250 and attached to both sides of the second end 320 of the cantilever arm 300 with fasteners 255, such as bolts or pins. This configuration allows the cantilever arm 300 to rotate between an open and closed position.

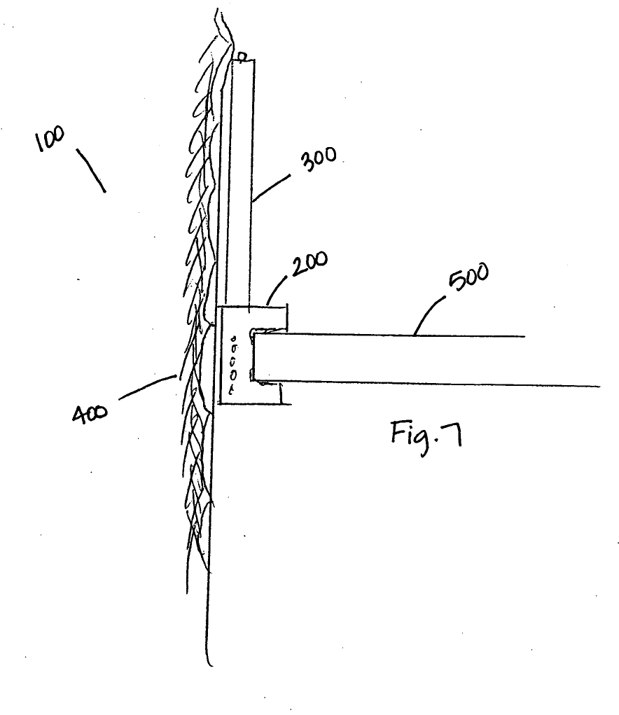

FIG. 6 depicts the net system 100 attached to the beam structure 500 with a web mount 260. The web mount 260 is made of a material that can be cut off when the net system 100 is no longer needed on the structure 500. This type of mounting apparatus 200 leaves a small repair area and is preferred when minor cosmetic damage is necessary. The web mount 260 material attaches to both sides of the cantilever arm 300 and to both sides of the structure beam 500 while still allowing the cantilever arm 300 to rotate between an open and closed position. The web mount is secured to the structure 500 and cantilever arm 300 by either integrally attaching the web mount 260 into the structure 500 or by attaching the web mount 260 to the structure 500 with an eyebolt.

As shown in FIG. 7, when the cantilever arm 300 is in the closed position, the net 400 is against the structure 500. This arrangement allows the net 400 to be easily repaired by a crew on the structure 500 and protected from inclement weather and high winds. A clamp mount 220 is shown as the mounting apparatus 200 in FIG. 7, but any mounting apparatus 200 disclosed in FIGS. 2-6 could be used in its place. When in the closed position, the cantilever arm 300 is secured with a rope or tie so that it will stay in place.

The preferred embodiment of the invention is described above, in the Drawings, and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A net system comprising:
A. at least one mounting apparatus;
B. at least one cantilever arm, said cantilever arm further comprising a first end and a second end;
C a net;
D. said first end of said cantilever arm is rotatably coupled to said mounting apparatus;
E. said mounting apparatus is coupled to a structure; and
F. said net coupled to said second end of said cantilever arm such that said net adjusts between an open position and a closed position as said cantilever arm rotates and forms a barrier around said structure.

2. The net system of claim 1 wherein said mounting apparatus is selected from the group consisting of a mounting plate, a clamp mount, a parapet clamp mount, an eyebolt, or a web mount.

3. The net system of claim 1 wherein said cantilever arm is coupled to said mounting apparatus with a pivot pin such that said cantilever arm rotates around an axis of said pivot pin.

4. The net system of claim 1 wherein said net is comprised of a plurality of sections such that said net sections are coupled to each other with a plurality of fasteners.

5. The net system of claim 4 wherein said fasteners are selected from the group consisting of hooks, loops, wire, or rope.

6. A method of using a net system comprising the steps of:
A. rotatably coupling a first end of at least one cantilever arm to at least one mounting apparatus;
B. coupling said mounting apparatuses to a structure;
C. coupling a net to a second end of said cantilever arm such that said net adjusts between an open position and a closed position as said cantilever arm rotates and forms a barrier around said structure.

7. The method of claim 6 further comprising the step of selecting said mounting apparatus from the group consisting of a mounting plate, a clamp mount, a parapet clamp mount, an eyebolt, or a web mount.

8. The method of claim 6 further comprising the step of coupling said cantilever arm to said mounting apparatus with a pivot pin such that said cantilever arm rotates around an axis of said pivot pin.

9. The method of claim 6 further comprising the step of coupling a plurality of net sections to each other with a plurality of fasteners.

10. The method of claim 9 further comprising the step of selecting said fasteners from the group consisting of hooks, loops, wire, or rope.
